(19) United States
(12) Patent Application Publication
(10) Pub. No.: US 2018/0322419 A1
(43) Pub. Date: Nov. 8, 2018

(54) Model Driven Modular Artificial Intelligence Learning Framework

(71) Applicant: CenturyLink Intellectual Property LLC, Denver, CO (US)

(72) Inventor: Michael K. Bugenhagen, Leawood, KS (US)

(21) Appl. No.: 15/974,228

(22) Filed: May 8, 2018

Related U.S. Application Data
(60) Provisional application No. 62/503,166, filed on May 8, 2017.

(51) Int. Cl. G06N 99/00; G06N 5/04

(52) U.S. Cl. CPC G06N 99/005; G06N 5/043

(57) ABSTRACT

Novel tools and techniques for a model-driven AI learning framework are provided. A system includes a user device and an artificial intelligence engine. The artificial intelligence engine may include a processor, and a non-transitory computer readable medium comprising instructions executable by the processor to perform an action responsive to a trigger, based at least in part on one or more data, allow one or more functions of the artificial intelligence engine to be accessed by the user device, and allow the one or more user inputs of the trigger to be defined, allow the one or more data inputs to be defined, and allow the action responsive to the trigger to be defined.

### CROSS REFERENCE TO RELATED APPLICATIONS

This application claims priority to U.S. Provisional Patent Application Ser. No. 62/503,166 filed May 8, 2017 by Michael K. Bugenhagen (attorney docket no. 020370-033601US), entitled “AI Smart Application Model Driven Customization Framework.” The disclosures of this application are incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to machine learning systems and methods, and more particularly to tools for customizing artificial intelligence learning behavior.

### BACKGROUND

Smart, network-connected devices deployed with artificial intelligence (AI) software or Advanced Intelligent Network (AIN) software, such as AI/AIN agents, are becoming increasingly commonplace. Many smart devices, such as smart phones, personal computers, media players, set-top boxes, and smart speakers feature proprietary AI software (e.g., AI agents and AI assistants), allowing users to interact with their device in various ways. Other personal electronics, household appliances, televisions, and other devices are also beginning to be deployed with AI software.

Conventional AI software and learning algorithms are typically defined and managed centrally by a vendor or service provider. Thus, the manner in which a user or a third-party interacts with a respective AI software and trains AI behavior is often constrained to a context or environment as defined by the vendor of the AI software. Thus, options to customize AI software and behavior are often unavailable or limited.

Accordingly, tools and techniques for a model-driven modular AI learning framework are provided.

### BRIEF DESCRIPTION OF THE DRAWINGS

A further understanding of the nature and advantages of the embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram of a topology of a system for a model-driven AI learning framework, in accordance with various embodiments;

FIG. 2 is a schematic representation of a managed object, in accordance with various embodiments;

FIG. 3 is a schematic block diagram of system for a model-driven AI learning framework, in accordance with various embodiments;

FIG. 4A is a flow diagram of a method for handling a trigger for an AI engine, in accordance with various embodiments;

FIG. 4B is a flow diagram of a method for a model-driven AI learning framework, in accordance with various embodiments;

FIG. 5 is a schematic block diagram of a computer system for providing a model-driven AI learning framework, in accordance with various embodiments; and

FIG. 6 is a block diagram illustrating a networked system of computing systems, which may be used in accordance with various embodiments.

### DETAILED DESCRIPTION OF CERTAIN EMBODIMENTS

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In an aspect, a system for a model-driven AI learning framework. The system includes a user device and an artificial intelligence engine. The user device may be coupled to a communications network. The artificial intelligence engine may be in communication with the user device and further include a processor, and a non-transitory computer readable medium comprising instructions executable by the processor to perform an action responsive to a trigger, based at least in part on one or more data inputs. The trigger may include one or more user inputs. The instructions may further be executable to provide a learning application programming interface. The learning application programming interface may be configured to allow one or more functions of the artificial intelligence engine to be accessed. The instructions may further be executable to allow, via the learning application programming interface, the one or more user inputs of the trigger to be defined, allow the one or more data inputs to be defined, and allow the action responsive to the trigger to be defined.

In another aspect, an apparatus for a model-driven AI learning framework is provided. The apparatus includes a processor and a non-transitory computer readable medium comprising instructions executable by the processor to perform an action responsive to a trigger, based at least in part on one or more data inputs. The trigger may include one or more user inputs. The instructions may further be executable to provide a learning application programming interface. The application programming interface may be configured to allow one or more functions of the artificial intelligence engine to be accessed by a user. The instructions may further be executable to allow, via the learning application programming interface, the one or more user inputs of the trigger to be defined, allow the one or more data inputs to be defined, and allow the action responsive to the trigger to be defined.

In a further aspect, a method for a model-driven AI learning framework is provided. The method includes performing, via an artificial intelligence engine, an action responsive to a trigger, based at least in part on one or more data inputs, wherein the trigger includes one or more user inputs. The method continues by providing, at the artificial intelligence engine, a learning application programming interface configured to allow one or more functions of the artificial intelligence engine to be accessed. The method further includes defining, via the learning application programming interface, the one or more user inputs of the trigger, defining, via the learning application programming interface, the one or more data inputs, and defining, via the learning application programming interface, the action responsive to the trigger.

Various modifications and additions can be made to the embodiments discussed without departing from the scope of the invention. For example, while the embodiments described above refer to specific features, the scope of this invention also includes embodiments having different combination of features and embodiments that do not include all the above described features.

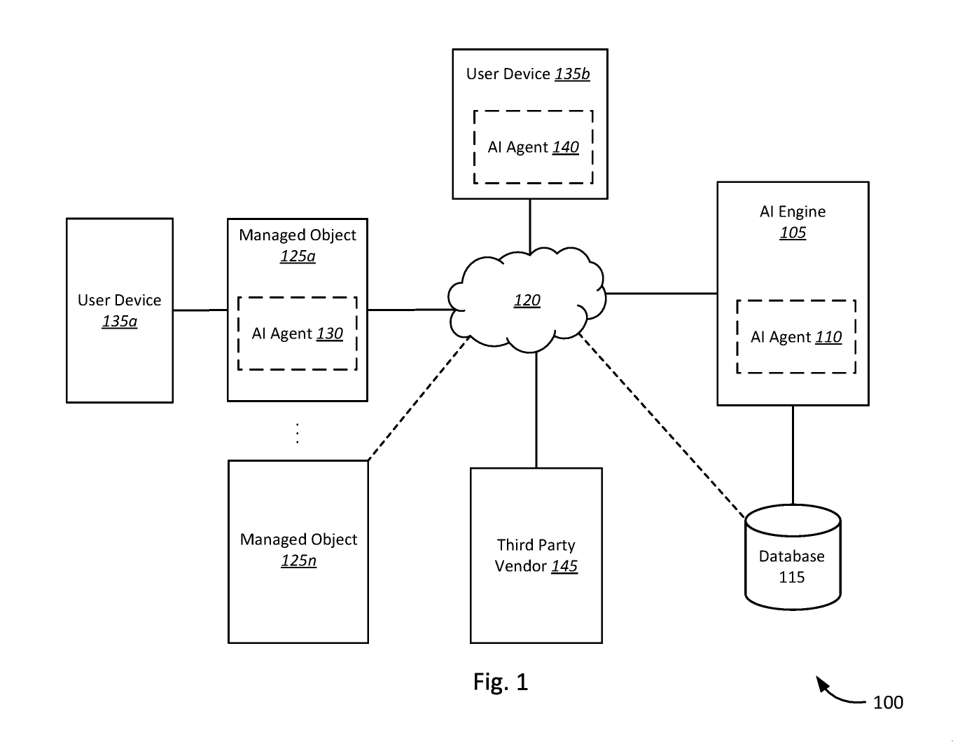

FIG. 1 is a block diagram of a topology for a system 100 for a model-driven AI learning framework, in accordance with various embodiments. The system 100 may include, an AI engine 105, optional AI agent 110, database 115, network 120, one or more managed objects 125a-125n (collectively, the managed objects 125), optional AI agent 130, first user device 135a, second user device 135b, optional AI agent 140, and third-party vendor 145. It should be noted that the various components of the system 100 and associated topologies are schematically illustrated in FIG. 1, and that modifications to the architecture or topological arrangement of the system 100 may be possible in accordance with various embodiments.

In various embodiments, the AI engine 105 may optionally include an AI agent 110. The AI engine 105 may be communicatively coupled to the database 115. The AI engine 105 may further be coupled to a network 120. One or more managed objects 125a-125n may be coupled to the AI engine 105 via the network 120. Each of the managed objects 125 may further be coupled to the first user device 135a, second user device 135b, third party vendor 145, or to other managed objects of the one or more managed objects 125a-125n. A first managed object 125a may include an optional AI agent 130. The first managed object 125a may further be coupled to a first user device 135a. A second user device 135b may be coupled to the network 120. The second user device 135b may include an optional AI agent 140. The second user device 135b may be coupled to the AI engine 105, one or more managed objects 125a-125n, or the third-party vendor 145 via the network 120. A third-party vendor 145 may also be coupled to the network 120. The third-party vendor 145 may be coupled to the AI engine 105, the managed objects 125, or the first or second user devices 135a, 135b.

In various embodiments, the AI engine 105 may be implemented in hardware, software, or both hardware and software. The AI engine 105 may include, without limitation, one or more machine readable instructions, such as a computer program or application, a server computer hosting the software, a dedicated custom hardware, such as a single-board computer, field programmable gate array (FPGA), modified GPU, application specific integrated circuit (ASIC), or a system on a chip (SoC). In further embodiments, the AI engine 105 may further include a specifically targeted hardware appliance, or alternatively, a database-driven device that performs various functions via dedicated hardware as opposed to a central processing unit (CPU).

In various embodiments, the AI engine 105 may be configured to make decisions based on data obtained from various devices, such as the managed objects 125, first and second user devices 135a, 135b, or a third-party vendor 145. The AI engine 105 may obtain data in the form of data streams generated by various devices. For example, data may be generated by various devices as continuous data streams, and pushed by the devices substantially in real-time. In other embodiments, the AI engine 105 may obtain data by polling the devices periodically, or upon request. In yet further embodiments, data from the various devices may be transmitted, organized, and stored in a database 115. The database 115 may include either (or both) a relational (e.g., a structured query language (SQL) database, Apache Hadoop distributed file system, ElasticSearch index) database, or a non-relational (e.g., NoSQL) database. Thus, the AI engine 105 may be configured to obtain data from the database 115. Data generated by the devices may vary based on the respective device, as will be described in greater detail below with respect to the individual devices.

Accordingly, in various embodiments, the AI engine 105 may be configured to make decisions based on the data. In some embodiments, the AI engine 105 may further be configured to receive an input, such as a query or command, from a user, and to perform an action based on the input. In some examples, the AI engine 105 may be configured to obtain the appropriate data from the appropriate device based on the user input. Decisions may be made according to one or more rules, or one or more algorithms for handling the user input and/or the obtained data. Accordingly, decisions may result in one or more actions being performed based on the obtained data and/or user input. In various embodiments, the AI engine 105 may include a correlation engine, threshold engine, or both. The correlation engine may be configured to construct groupings and relationships based on various events and inputs (e.g., obtained data and/or user inputs). The threshold engine may be configured to establish thresholds and determine thresholds for when an action should be taken. For example, the threshold engine may be configured to implement various types of logic for determining thresholds. For example, in some embodiments, the threshold engine may be configured to utilize fuzzy logic algorithms for determining thresholds and to make decisions. Accordingly, the AI engine 105 may be configured to utilize various types of classification models, including, without limitation, a binary classification model, multiclass classification model, or a regression model in making its decisions. AI engine 105 may further be configured to utilize one or more of a rules-based or model-based machine learning approach.

In some examples, the rules (e.g., algorithms) utilized in an AI platform may lead to erroneous decisions being made by an AI software. Conventionally, these rules and/or algorithms are defined by a service provider for a respective AI application. Although conventional AI applications may be programmed to modify its behavior, the customer is often limited in the customization of the AI application. Accordingly, in various embodiments, the AI engine 105 may be configured to be refined (e.g., tuned) to each user's respective context. For example, in some embodiments, the user may be an end user, and the AI engine 105 may be refined by the end user for a desired context, such as, without limitation, in a personal computer, in a smartphone, in a digital media player or entertainment system, for personal use, or for business use. Thus, the context may inform, without limitation, the type of device with which the AI engine 105 interacts, and a setting in which the device may be used. In further embodiments, the user may be a third-party vendor 145 of a service or application offered on a service provider's platform on which the AI engine 105 may be available. Accordingly, the AI engine 105 may further be configured to be refined by the third-party vendor 145, to refine rules and/or algorithms followed by the AI engine 105 in the context of the third-party vendor's 145 service or application.

In various embodiments, refining or tuning of the AI engine 105 may include the removal of “false positives” resulting from the algorithms used by the AI engine 105. Removal of false positives may include learning, by the AI engine 105, that specific states are outside the capabilities of a specific AI system (e.g., the AI engine 105, or more broadly the system 100). For example, an incorrect decision may be made by the AI engine 105 in response to a user input or obtained data. In some cases, this may result in an undesired effect or action, the incorrect effect or action, or a decision that may not be able to be performed by the system 100 or a device in the system 100. Thus, the AI engine 105 and its respective rules may be refined by a user or third-party vendor to remove the false positives (e.g., incorrect decisions) from the AI engine 105.

To accelerate the learning process, the AI engine 105 may further include a query and feedback mechanism. The feedback mechanism may include, without limitation, an API (e.g., a learning API), interface, or trigger (e.g., a physical button, switch, or trigger on a device on which the AI engine 105 may be deployed, or with which the AI engine 105 is communicatively coupled; or a software button). The feedback mechanism may be configured to cause the AI engine 105 to enter a learning mode. In the learning mode, the AI engine 105 may be configured to generate a snapshot of state (or derived) inputs (e.g., obtained data from the managed objects 125, first and second user devices 135a, 135b, database 115, or user inputs), and prevent the incorrect decision from being made again. In some embodiments, in the learning mode, the AI engine 105 may be configured to allow a user, such as, without limitation, an end-user, trainer, third-party vendor 145, training software or tool, or a service provider, to define or otherwise provide a correct decision to the AI engine 105, via the feedback mechanism. In further embodiments, the AI engine 105 may be configured to allow a user to define new or additional state inputs to be monitored by the AI engine 105 for decision making or altering machine learning/AIN algorithms, or alternatively, an associated AI engine 110, 130, 140. In some further examples, the AI engine 105 may be configured to allow a user to flag the incorrect decision and associated snapshot of state inputs for artifact analysis, which includes, without limitation, root cause analysis and diagnosis. For example, in some cases, the AI engine 105 may include a separate false positive register for flagging of the incorrect decision and snapshot of state inputs. Accordingly, in some examples, the AI engine 105 may be configured to allow a user to set a flag in the false positive register, identifying an address, or set of addresses, in memory associated with the state snapshot. Thus, the learning framework may be referred to as model-driven, in which a trigger and an associated set of inputs and output, including, without limitation, the trigger, state inputs, rules for processing the state inputs, and actions taken responsive to the trigger, may be considered a model. Thus, in some embodiments, each trigger and responsive action may be based on a model, or include data, values, and characteristics within the model.

In various embodiments, the AI engine 105 may, optionally, further include one or more AI agents 110. An AI agent 110 may represent an instance of an AI software associated with a respective user (e.g., an end-user or third-party vendor). For example, an AI assistant, agent, or other instance of AI software, configured to interface with the AI engine 105. The AI engine 105 may thus be configured to provide its computing resources to the AI agent 110. Thus, each AI agent 110 may be hosted on the same device (e.g., a server computer or other hardware) hosting the AI engine 105, but associated with a respective user. The AI agent 110 may, thus, be accessible remotely by the respective user via the network 120. In yet further embodiments, each AI agent 110 may include at least part of the AI engine 105, the AI engine 105 defining at least part of each instance of the one or more AI agents 110.

In various embodiments, the database 115 may be configured to provide data generated by various devices to which the database 115 is coupled. Thus, in some examples, various devices (e.g., managed objects 125, user devices 135, or third-party vendor 145) may be configured to transmit data to the database 115 directly, via the network 120. In some embodiments, the database 115 may utilize a publish-subscribe scheme, in which the database may be configured to allow various devices, tools (e.g., telemetry tools), and their sub-interfaces to publish their data as respective data streams to the database 115. The AI engine 105 may then be subscribed to the database 115 to listen to the respective data streams. In alternative embodiments, the AI engine 105 may be directly coupled to the various devices, tools, and sub-interfaces to receive the respective data streams. Thus, in some examples, the AI engine 105 may itself employ a publish-subscribe scheme for obtaining data streams from the respective devices, tools, and sub-interfaces.

In some embodiments, data may be generated by various devices as continuous data streams and pushed by the devices substantially in real-time. In other embodiments, the AI engine 105 may obtain data by polling the devices periodically, or upon request. In yet further embodiments, data from the various devices may be transmitted, organized, and stored in a database 115. The database 115 may include either (or both) a relational (e.g., a structured query language (SQL)) database, or a non-relational (e.g., NoSQL) database. In further embodiments, the database 115 may further include searchable indices or other data structures (e.g., an Apache Hadoop distributed file system, or an ElasticSearch index). In some embodiments, the AI engine 105 may be configured to organize various data streams into the database 115, searchable data indices, or other data structures. Thus, the AI engine 105 may be configured to obtain data from the database 115, or respectively from each device. Furthermore, data generated by the devices may vary based on the respective device, as will be described in greater detail below with respect to the individual devices.

The system 100 may further include one or more managed objects 125a-125n. Managed objects 125 may include, without limitation, various types of network resources. Network resources may refer to network devices themselves, as well as software, drivers, and libraries associated with the network device. Information regarding the network resource, such as, without limitation, data indicative of a network location, physical location, telemetry information, product attributes, service attributes, usage metrics, performance metrics, state information, fault information, and any associated metadata may also be considered a managed object 125a-125n. Thus, in some embodiments, a managed object 125 may be an abstraction of a device, service, or other network resource. For example, in some embodiments, a cloud portal may be provided. Network resources made available via the cloud portal, such as a service, application, product, or function of the cloud portal, may each be a respective managed object 125a-125n with respective information regarding a service object used to manage the associated managed object 125a-125n. Moreover, managed objects 125 may be used as telemetry tools, to generate telemetry information regarding the associated network resource. For example, an application, such as an AI engine 105 may use telemetry from a network service to make decisions about the state of network connectivity to, for example, a PSTN switch.

In various embodiments, each managed object 125a-125n may be coupled to one or more other managed objects 125, a user device 135a, 135b, third party vendor 145, database 115, or the AI engine 105. For example, in some embodiments, a first managed object 125a may be coupled to a first user device 135a. Accordingly, the first managed object 125a may be configured to obtain data generated by a first user device 135a, or user input from the first user device 135a. The data and/or user input may be provided to the AI engine 105, or alternatively the AI agent 130, for further processing.

The first managed object 125a may further include an instance of the AI agent 130. As previously described with respect to the AI agent 110 of the AI engine 105, the AI agent 130 may similarly represent an instance of an AI software. In this case, the AI agent 130 may be associated with the respective managed object 125a, or in some cases, a respective user. For example, an AI agent, an AI assistant, or other instance of AI software, may be configured to interface with the AI engine 105, and may be controlled by the AI engine 105. The AI engine 105 may be configured to provide its computing resources to the AI agent 130. In some examples, the AI agent 130 may be accessible via the first user device 135a, or in some embodiments, remotely via the network 120. In yet further embodiments, each AI agent 130 may include at least part of the AI engine 105, the AI engine 105, in turn, defining at least part of each instance of the one or more AI agents 110, 130, 140.

In some embodiments, an nth managed object 125n may be coupled to a second user device 135b via the network 120. The second user device 135b may, in some cases include a respective AI agent 130. Thus, in various embodiments, the AI agents 110, 130, 140 may be deployed on various devices as appropriate for a given context. The AI agent 140 of the second user device 135b may be configured to obtain user inputs from the second user device 135b, and to obtain data from the various devices (e.g., user devices, managed objects 125, or third-party vendor 145) via the network 120. The AI agent 140 may further access the resources of the AI engine 105 via the network 120. As previously described, the AI agent 140, an AI assistant, or other instance of AI software, may be configured to interface with the AI engine 105, and/or may be controlled by the AI engine 105. The AI engine 105 may be configured to provide its computing resources to the AI agent 130. In some examples, the AI agent 130 may be accessible via the first user device 135a, or in some embodiments, remotely via the network 120. In yet further embodiments, each AI agent 130 may include at least part of the AI engine 105, the AI engine 105, in turn, defining at least part of each instance of the one or more AI agents 110, 130, 140.

Accordingly, in various embodiments, the AI engine 105 may be configured to be coupled to each of the managed objects 125. In some embodiments, one or more of the managed objects 125a-125n may be configured to generate a data and/or a data stream. In some embodiments, the managed objects 125 may transmit their respective data to the database 115 via the network 120. In other embodiments, data generated by the managed objects 125 may be provided directly to the AI engine 105 or a respective AI agent 110, 130, 140. The AI engine 105 and/or AI agent 110, 130, 140 may thus be configured to make decisions, responsive to a user input, based on the data. As previously described, in various embodiments, the AI engine 105 and/or AI agent 110, 130, 140 may be configured to allow a user, such as, without limitation, an end-user, trainer, third-party vendor 145, training software or tool, or a service provider, to define or otherwise provide a correct decision to the AI engine 105 and/or AI agent 110, 130, 140, via the feedback mechanism, which, in some cases, may be accessed via a managed object 125, or a user device 135.

In various embodiments, the system 100 may further include the systems of a third-party vendor 145. Third-party vendor 145 systems may include, without limitation, servers, network resources, applications, and services made available to an end user. In some embodiments, the third-party vendor 145 may make a resource or service available via a respective managed object 125a-125n. In some examples, the third-party vendor 145 may be able to interface with the AI engine 105, or alternatively, an AI agent 110, 130, 140, to define, or alternatively, to modify AI behavior as the third-party vendor desires with respect to its application and/or service. Thus, in various embodiments, a third-party vendor 145 may be able to access a feedback mechanism, via network 120. Thus, the third-party vendor 145 may be coupled to the managed objects 125, user devices 135, or the AI engine 105, and configured to access a respective feedback mechanism, and to define or modify rules applicable to the third-party vendor 145, or applicable to a service or resource provided by the third-party vendor 145.

The network 120 may, therefore, include various types of communication networks. a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an IR network; a wireless network, including, without limitation, a network operating under any of the IEEE 802.11 suite of protocols, the Bluetooth™ protocol known in the art, the Z-Wave protocol known in the art, the ZigBee protocol or other IEEE 802.15.4 suite of protocols known in the art, low-power wide area network (LPWAN) protocols, such as long range wide area network (LoRaWAN), narrowband IoT (NB-IoT); long term evolution (LTE); Neul; Sigfox; Ingenu; IPv6 over low-power wireless personal area network (6LoWPAN); Wi-Fi; cellular communications (e.g., 2G, 3G, 4G, 5G & LTE); Thread; near field communications (NFC); radio frequency identification (RFID); and/or any other wireless protocol; and/or any combination of these and/or other networks.

In some embodiments, the AI engine 105, managed objects 125, user devices 135, database 115, and third-party vendor 145 system may each include a communications subsystem to communicate over the network 120. Accordingly, the AI engine 105, managed objects 125, user devices 135, database 115, and/or third-party vendor 145 system may include, without limitation, a modem chipset (wired, wireless, cellular, etc.), an infrared (IR) communication device, a wireless communication device and/or chipset (such as a Bluetooth™ device, an 802.11 device, a WiFi device, a WiMax device, a WWAN device, a Z-Wave device, a ZigBee device, cellular device, etc.), and/or the like. The communications subsystem may permit data to be exchanged with the network 120, with other computer or hardware systems, and/or with any other devices.

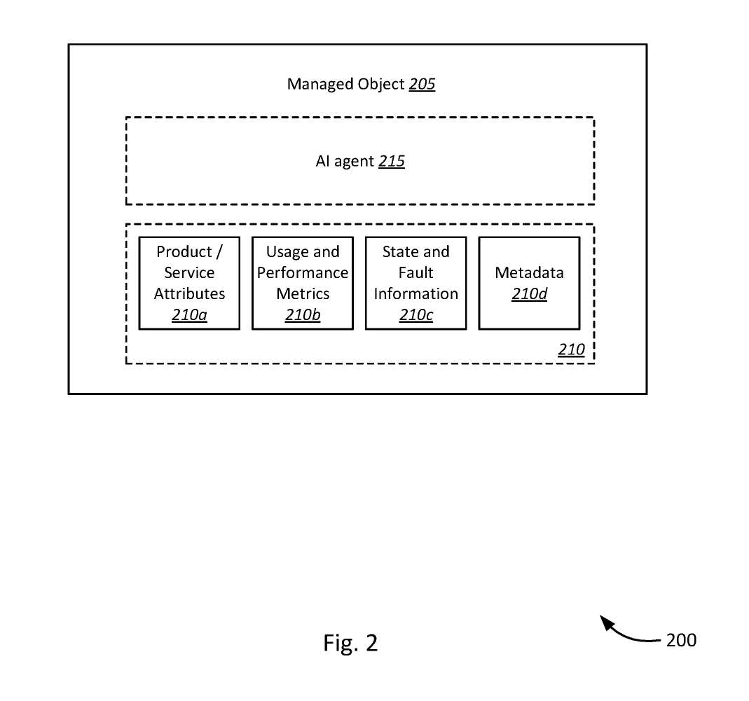

FIG. 2 is a schematic representation 200 of a managed object 205, in accordance with various embodiments. The managed object 205 may include product/service attributes 210a, usage and performance metrics 210b, state and fault information 210c, and metadata 210d (collectively referred to as data 210). The managed object 205 may, in some embodiments, also include an instance of the AI agent 215. It should be noted that the various types of data 210, and the AI agent 210 are schematically illustrated in FIG. 2, and that modifications to the managed object 205 may be possible in accordance with various embodiments.

As previously described, the managed object 205, in various embodiments, may include different network resources and data 210 associated with a respective network resource. For example, network resources may refer to network devices, software, drivers, libraries, and components. The managed object 205 may further include data 210 associated with the respective network resource. In various embodiments, information associated with the respective network resource may include product/service attributes 210a, usage and performance metrics 210b, state and fault information 210c, and metadata 210d. Thus, in various embodiments, the managed object 205 may be an abstracted representation of a network resource, including data 210 about the network resource.

The managed object 205 may be configured to generate data 210 and/or a data stream, which may be accessible by an AI engine. In some embodiments, the data stream may include information regarding the associated network resource, such as, without limitation, data indicative of a network location, physical location, telemetry information, product attributes, service attributes, usage metrics, performance metrics, state information, fault information, and any associated metadata. For example, in some embodiments, the managed object 205 may be a telemetry tool configured to generate telemetry information regarding an associated network resource. For example, an application, such as the AI engine may use telemetry regarding a network service to make decisions about the state of connectivity to a respective network.

In various embodiments, the managed object 205 may be coupled to other managed objects, a network resource, a user device, third party vendor, database, or the AI engine. For example, in some embodiments, a managed object 205 may be configured to obtain data generated by a user device, network resource, or a third-party vendor. The managed object 205 may be configured to provide the data and/or user input may be provided to a database, AI engine, or alternatively, directly to an AI agent 215.

In some embodiments, the managed object 205 may further include an instance of the AI agent 215. The AI agent 215 may be an instance of an AI software in communication or otherwise associated with the managed object 205. The AI agent 215 may include, for example, an AI agent, an AI assistant, or other instance of AI software, and may be configured to interface with the AI engine 105. In some examples, the AI agent 215 may be in communication with an AI engine. Thus, in some embodiments, the AI engine may be configured to provide its computing resources to the AI agent 215. The AI agent 215 may be configured to access data 210 generated or otherwise obtained by the managed object 205.

In some embodiments, the managed object 205 may be configured to generate data 210 and/or a data stream. In some embodiments, the managed objects 205 may transmit their respective data 210 to a database, or alternatively, to an AI agent 215, or a remote AI engine. In various embodiments, the managed object 205 may be configured to provide product/service attributes 210a. Product/service attributes 210a may be generated at the managed object 205, in substantially real-time as a data stream, generated periodically (e.g., polled by the managed object, AI agent 215, or AI engine), or upon request by an AI engine or the AI agent 215. In some embodiments, the managed object 205 may be configured to obtain product/service attributes 210a from an associated network resource (such as a computer server or database). Product/service attributes 210a may include, without limitation, data indicative of a product or service with which the network resource is associated. For example, the managed object 205 may be associated with a content server. The content server, in turn, may be associated with a video streaming service offered by a third-party vendor, or by a network service provider. Thus, the product/service attributes 210a may indicate, without limitation, the name of the product or service, the service provider or third-party vendor associated with the product or service, and attributes further defining the product or service (e.g., quality of service, content restrictions and permissions, subscription information, etc.).

In various embodiments, managed object 205 may further be configured to provide usage and performance metrics 210b. Like the product/service attributes 210a, the usage and performance metrics 210b may be generated in substantially real-time as a data stream, generated periodically (e.g., polled by the managed object, AI agent 215, or AI engine), or upon request by an AI engine or the AI agent 215. In some embodiments, the managed object 205 may be configured to obtain usage and performance metrics 210b from an associated network resource. Usage and performance metrics 210b may include, without limitation, data indicative of the usage and performance of the respective network resource with which the managed object 205 is associated. Using the previous example, the managed object 205 may be associated with a content server. The usage and performance metrics 210b may indicate, without limitation, usage metrics for the content server, such as data usage, the number of times content was accessed, the type of content or specific titles requested, number of unique customers or requests for content handled, uptime, and utilization rates (e.g., amount of time the server was in use vs. not in use). The usage and performance metrics 210b may further include, without limitation, performance metrics, such as quality of service metrics, network speed, bandwidth availability, and latency.

In various embodiments, managed object 205 may be configured to provide state and fault information 210c. State and fault information may include, without limitation, state information for the network resource associate with the managed object 205, and fault information associated with the network resource, or service provided by the network resource. State and fault information 210c may be generated in substantially real-time as a data stream, generated periodically, or upon request by an AI engine or AI agent 215. In some embodiments, the managed object 205 may be configured to obtain state and fault information 210c from the associated resource. In some embodiments, state and fault information 210c may be generated responsive to the presence of one or more fault conditions. Fault conditions may be indicative of a fault associated with a network resource or a service provided by the network resource. For example, fault conditions may be associated with network faults, hardware errors and failures, predictive alerts, anomalies, connection failures, and other errors. State information may be indicative of the state of an associated network resource or service provided by the network resource. State information may indicate a current state of one or more hardware components associated with the network resource, service availability, or a status of a network resource (e.g., active, busy, idle, etc.), or other information regarding the state of the network resource.

In various embodiments, managed object 205 may be configured to provide metadata 210d associated with a network resource, or service provided by the network resource. Metadata may include further information associated with the other types of data. For example, metadata 210d may include further information about the product/service attributes 210a, usage and performance metrics 210b, and the state and fault information 210c. Continuing with the example of a content server, in some embodiments, metadata 210d may include information about one or more subscribers, types of content, titles of programs, closed captioning information associated with the content, electronic programming guide information, other information about a specific program or title, etc. Metadata 210d may further include information about the network resource associated with the managed object 205, such as, without limitation, hardware vendor information for hardware and other components associated with the network resource, software version information, software vendor information, hardware identifiers and serial numbers, licenses and keys, etc.

Accordingly, in various embodiments, the managed object 205 may be abstracted representations of one or more associated network resources, and may provide data 210 to an AI engine, or alternatively an AI agent 215, for processing. In some embodiments, the managed object 205 may optionally include or otherwise be interfaced with an instance of an AI agent 215. The AI agent 215 may be an instance of an AI software associated with a respective user (e.g., an end-user or third-party vendor). For example, an AI assistant, agent, or other instance of AI software, configured to interface with an AI engine, which may be located remotely from the managed object 205. The AI engine may be configured to provide its computing resources to the AI agent 215. Thus, each AI agent 215 may be hosted on the same device (e.g., a server computer or other hardware) hosting the managed object 205.

Accordingly, in various embodiments, an AI engine, or alternatively, the AI agent 215, may be configured to make decisions and/or perform various actions based on the data 210 provided via a managed object. In some embodiments, the AI engine and/or AI agent 215, may further be configured to perform an action based on an input received from a user or tool associated with the managed object 205. In some examples, the AI agent 215 may be configured to obtain the appropriate data 210 and make decisions according to one or more rules, or one or more algorithms for handling the user input and/or the obtained data. Accordingly, decisions may result in one or more actions being performed based on at least one of the product/service attributes 210a, usage and performance metrics 210b, state and fault information 210c, and metadata 210d.

In some examples, the AI agent 215 and/or AI engine may further include a learning interface configured to allow customization of the AI agent 215 and/or AI engine. For example, in various embodiments, the AI agent 215 and/or AI engine may be configured to be refined (e.g., tuned) to a user's respective context. For example, in some embodiments, the user may be an end user, and the AI agent 215 and/or AI engine may be customized by an end user for a desired context, such as, without limitation, in a personal computer, in a smartphone, in a digital media player or entertainment system, set-top box, and whether the device is for personal use, or for business use. As previously described, the context may inform, without limitation, the type of devices with which the AI agent 215 and/or AI engine interacts, and a setting in which the device may be used. In further embodiments, the AI agent 215 and/or AI engine may be configured to modify its behavior to a context based, at least in part, on the data 210. In some embodiments, the AI agent 215 and/or AI engine may further be configured to be modified by, for example, a user, third-party vendor, software tools, or a service provider, to refine rules and/or algorithms followed by the AI agent 215 and/or AI engine to use the data 210.

In various embodiments, refining or tuning of the AI agent 215 and/or AI engine may include the removal of “false positives” resulting from the algorithms utilized by the AI agent 215 and/or AI engine. For example, in some embodiments, the AI agent 215 and/or an AI engine 105 may produce a false positive in response to a user input or obtained data 210, and a user, third-party vendor, service provider, or a software tool may remove the false positive by modifying an algorithm and/or data 210 utilized by the AI agent 215 and/or AI engine. As previously described, to accelerate the learning process, the AI agent 215 and/or AI engine may include a feedback mechanism, such as, without limitation, an API (e.g., a learning API), interface, or trigger (e.g., a physical button, switch, or trigger on a device or a software button). The feedback mechanism may be configured to cause the AI agent 215 and/or AI engine to enter a learning mode. In the learning mode, the AI agent 215 and/or AI engine may be configured to generate a snapshot of state inputs (e.g., the data 210 obtained from the managed object 205). The algorithms utilized by the AI agent 215 and/or AI engine, and/or data 210 may then be analyzed by a user, third-party vendor, service provider, or a software tool, and appropriate modifications may be made to produce a desired result from the AI agent 215 and/or AI engine. In some embodiments, in the learning mode, the AI agent 215 and/or AI engine may be configured to allow a user, such as, without limitation, an end-user, trainer, third-party vendor, training software or tool, or a service provider, to define or otherwise provide a correct decision to the AI agent 215 and/or AI engine, via the feedback mechanism. In further embodiments, the AI agent 215 and/or AI engine may be configured to allow a user to define new or additional state inputs to be monitored by the AI agent 215 and/or AI engine. For example, in some embodiments, the AI agent 215 and/or AI engine may utilize a subset of data 210 to make decisions. Thus, a subset of a product/service attributes 210a, usage and performance metrics 210b, state and fault information 210c, and metadata 210d may be used, or in some examples, may not be used at all. The user may, therefore, further define state inputs to include additional product/service attributes 210a, usage and performance metrics 210b, state and fault information 210c, and metadata 210d to be used by the AI agent 215 and/or AI engine in making decisions. In some further examples, the AI agent 215 and/or AI engine may be configured to perform artifact analysis in the state inputs (e.g., data 210), which includes, without limitation, root cause analysis and diagnosis.

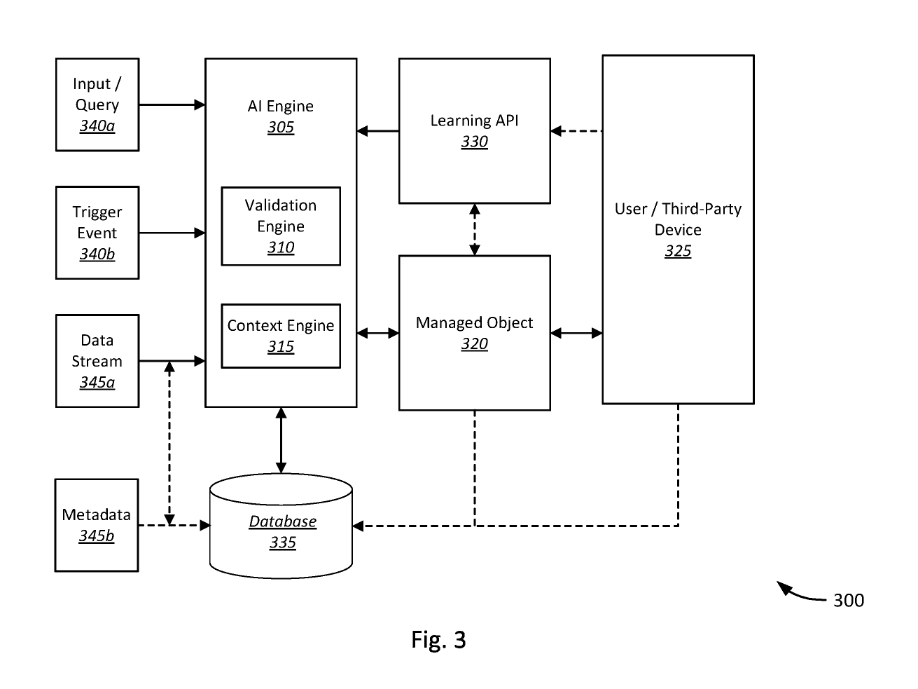

FIG. 3 is a schematic block diagram of system 300 for a model-driven AI learning framework, in accordance with various embodiments. The system 300 includes an AI engine 305, which further includes a validation engine 310 and context engine 315, managed object 320, a user/third-party device 325, learning API 330, database 335, input/query 340a, trigger event 340b (collectively “user inputs” 340), and a data stream 345a and associated metadata 345b (collectively “data inputs” 345). It should be noted that the various components of the system 300 are schematically illustrated in FIG. 3, and that modifications to the architecture and framework employed in system 300 may be possible in accordance with various embodiments.

In various embodiments, the AI engine 305 may include the validation engine 310 and the context engine 315. The AI engine 305 may be coupled to the managed object 320, and the learning API 330. The managed object 320 may be coupled to the user/third-party device 325. The managed object 320 may further, optionally, be coupled to the learning API 330 and/or database 335. The user/third-party device 325 may also, optionally, be coupled to the learning API 330 and/or the database 335. The learning API 330 may, therefore, be coupled to the AI engine 305. The learning API 330 may further be configured to receive inputs form the user/third-party device 325 and communicate with the managed object 320. The AI engine 305 may further be configured to receive input/query 340a, and trigger event data 340b. The AI engine 305 may also be configured to directly receive a data stream 345a and metadata 345b. The data stream 345a and metadata 345b may further be provided to the database 335.

As previously described with respect to FIGS. 1 & 2, the AI engine 305 may be configured to make decisions based on one or more inputs, including user inputs 340 and data inputs 345. For example, in some embodiments, the AI engine 305 may be configured to receive an input/query 340a user, and to perform an action responsive to the input/query 340a. The input/query 340a may include, without limitation, commands and queries from an end user, third-party vendor, service provider, or a software tool. In some examples, the query or command may be a spoken natural language query, e.g. “I want X,” “what is Y?,” “where is Z?,” etc. In some further embodiments, the input/query 340a may further include data inputs supplied by a user, third-party vendor, service provider, or a software tool in response to a prompt from the AI engine 305. In some embodiments, the AI engine 305 may be configured to monitor or otherwise detect the occurrence of a trigger event 340b. For example, in some embodiments, the AI engine 305 may monitor a data stream, a managed object 320, or a network device for the occurrence of a trigger event 340b. Alternatively, the AI engine 305 may receive a signal indicative of the occurrence of a trigger event 340b. The AI engine 305 may, thus, be configured to perform an action, or make decisions responsive to the occurrence of the trigger event 340b. In various embodiments, the AI engine 305 may determine the action to take or decision to make, based on a data input 345, such as data stream 345a or other metadata 345b, data obtained from the managed object 320, and the database 335.

Thus, in various embodiments, the AI engine 305 may be configured to parse the phrases to determine what is being asked of the AI engine 305. The AI engine 305 may further be configured to determine the inputs being observed and what triggers are active at the time of the input/query 340a or trigger event 340b. The AI engine 305 may make decisions according to one or more rules, or one or more algorithms for responding the user inputs 340, and handling the data inputs 345. Accordingly, in various embodiments, the AI engine 305 may include a correlation engine, threshold engine, or both, as previously described with respect to FIG. 1. In some examples, the rules (e.g., algorithms) utilized by the AI engine 305 may lead to erroneous decisions being made. Thus, the AI engine 305 may include a feedback mechanism. The feedback mechanism may include, without limitation, the learning API 330. The AI engine 305 may be configured to be refined via the learning API 330. In various embodiments, the learning API 330 may be configured to obtain a snapshot of various inputs, such as the user inputs 340 and data inputs 345, inputs from the managed object 320, user database 335, or user/third-party device 325, used by the AI engine 305 associated with the incorrect decision. In some embodiments, the learning API 330 may be accessed by a user, user device, third-party vendor, service provider, or a tool, such as a software tool. The learning API 330 may be remotely accessible on one or more devices hosting the AI engine 305, or directly accessible at the one or more devices hosting the AI engine 305.

In various embodiments, the refining or tuning of the AI engine 305 may include the addition, removal, or modification of existing triggers. For example, triggers may define, without limitation, phrases, words, inputs, conditions, and events that may cause a response in the AI engine 305 to perform an action or otherwise make decisions. For example, in various embodiments, the learning API 330 may be configured to allow the user inputs 340, such as input/query 340a and trigger event 340b, to be parsed and to observe what triggers were active or activated by the user inputs 340. In various embodiments, a trigger may cause the AI engine 305 to obtain various types of data inputs 345, including data stream 345a and metadata 345b, data from database 335, and/or data form managed object 320. Thus, a trigger may cause the AI engine 305 to collect, obtain, and process data. In some embodiments, the learning API 330 may be configured to determine words, phrases, inputs, conditions, and events which may be shared by more than one trigger. The learning API 330 may be configured to determine the coexistence and/or exclusivity between one or more triggers. For example, the learning API 330 may be configured to determine whether multiple triggers were activated for a given decision or action by the AI engine 305, based on the user inputs 340 or data inputs 345 provided to the AI engine 305 in the snapshot of state inputs.

In yet further embodiments, the learning API 330 may be configured to define thresholds and threshold types for certain types of user inputs 340 and/or data inputs 345, such as fuzzy and/or hard thresholds 330. For example, when a trigger defines a certain temperature threshold for an action to be taken, the learning API 330 may be configured to allow the temperature threshold to be defined utilizing fuzzy logic thresholds, or alternatively, define hard thresholds for the temperature. Similar thresholds may be defined for different inputs.

In various embodiments, the learning API 330 may be configured to allow inputs associated with a trigger to be defined or modified. For example, new inputs may be defined, or existing inputs may be modified or removed from a trigger, via the learning API 330, for the AI engine 305 to obtain and make decisions based, at least in part, on the new inputs. In some embodiments, a new input from the data stream 345a, or a new or additional data stream may be defined via the learning API 330. Similarly, new inputs from metadata 345b, or different metadata, new inputs from the database 335 or new databases, and new inputs from the managed object 320 or a new managed object altogether, may be defined via the learning API 330. For example, a first trigger may cause the AI engine 305 to obtain a data input, for example from the data stream 345a, indicative of a moisture level. The learning API 330 may be configured to allow a user to define a new data input indicating weather conditions, associated with the first trigger. Thus, in addition to obtaining a moisture level from a moisture sensor, the AI engine 305 may further obtain weather data from a data input 345, managed object 320, database 335, or a new data source. In addition, the new input may, in some embodiments, be defined to include a value, and at least one derivative of the value. For example, the value may be associated with a position, a first derivative value may indicate a speed, and a second derivative value may indicate acceleration.

Once the triggers and inputs have been modified, in some embodiments, the learning API 330 may be configured to trigger the validation engine 310. The validation engine 310 may be configured to control how and when to test a decision made by the AI engine 305. For example, the learning API 330 may allow the removal of “false positives” resulting from the algorithms used by the AI engine 305, as previously described. Removal of false positives may include learning, by the AI engine 305, that specific states are outside the capabilities of a specific AI system (e.g., the AI engine 305, or more broadly the system 300). Thus, in various embodiments, the validation engine 310 may be configured to allow a user to flag an incorrect decision and associated snapshot of state inputs, or to automatically flag incorrect decisions for removal by a user via the learning API 330. Alternatively, in some embodiments, the validation engine may be configured to generate a report including one or more flagged decisions, and present them for review by a user or tool. Accordingly, in various embodiments, the validation engine 310 may be configured to allow both manual and automated flagging of decisions made by the AI engine 305.

In various embodiments, the AI engine 305 may further include a context engine 315. The context engine 315 may be configured to further modify and define AI engine 305 behavior in a respective context, and to perform sanity testing. For example, in some embodiments, the context engine 315 may be configured to determine a context for various inputs, such as user inputs 340 and data inputs 345, as well as decisions made by the AI engine 305. As previously described, a context may define, without limitation, the type of devices with which the AI engine 305 interacts, and a setting in which the device may be used. For example, in some embodiments, the context engine 315 may be configured to determine, as part of the context, that a user input 340 was generated by an end user, from a set top box, at a customer's premises. Thus, in some embodiments, the AI engine 305 may be configured to modify its behavior to a respective context. In some embodiments, a context engine 315 may be configured to associate the context with a trigger. For example, the context may be associated with one or more user inputs 340, data inputs 345, inputs from the managed object 320, or database 335. In some examples, a trigger may be associated with multiple contexts. Depending on the context determined by the context engine 315, a trigger may utilize a different subset of user inputs 340, data inputs 345, inputs from the managed object 320, and inputs from database 335.

In some embodiments, the context engine 315 may be configured determine contexts based on one or more factors. For example, factors may include, without limitation, a geographic location, type of device, user information, service information, application information, sensor inputs (e.g., a microphone, camera, photodetector, global navigation satellite system (GNSS) receiver, accelerometer, gyroscope, moisture reader, thermometer, rangefinder, and motion detector, among many other types of sensors), time of day, or date. Thus, the context engine 315 may be configured to determine a context based on a respective set of factors. In some embodiments, the context engine 315 may be configured to allow contexts to be defined by a user, via the learning API 330. Thus, a context may customizable and/or defined through the context engine 315. In some embodiments, this may include defining one or more factors.

In further embodiments, the context engine 315 may further be configured to perform sanity testing (e.g., a sanity check). In some embodiments, sanity testing may further be context dependent, and/or rely on one or more factors used to determine the context to intervene before an action is made by the AI engine 305 according to a trigger. For example, a sanity check may indicate whether one or more additional factors, contexts, data inputs 345, or inputs from managed object 320 or database 335 should be considered by the AI engine 305 before an action is performed. In various embodiments, a sanity check may further include historic usage, usage patterns, and other usage information to determine whether a decision made by the AI engine 305 should be performed, prevented from being performed, and/or whether to flag the decision made by the AI engine 305. In one example, an AI engine 305 may be part of an automated cruise control system for a vehicle. The AI engine 305 may be configured to generate one output as part of a system for automatically adjusting the speed of a vehicle (e.g., accelerate, decelerate, brake) according to the speed of objects passing the vehicle. In this example, the AI engine 305 may be configured to generate an output based on the speed of passing objects as determined by an optical sensor. Data inputs 345 considered by the AI engine 305 may include image data, and algorithms for determining the speed and direction of an object passing the vehicle. In some examples, high winds may cause objects to fly past the optical sensor at high speeds, which may falsely generate a signal for the vehicle to decelerate or brake. Thus, the context engine 315 may be configured to perform a sanity check before deciding that the vehicle should decelerate or brake. For example, the context engine 315 may be configured to determine that for the route taken, and the road taken, the speeds detected by the optical sensor exceed expectations beyond a threshold amount. In some embodiments, the context engine 315 may further look at weather conditions as a data input, to determine that the area is experiencing high winds. In yet further embodiments, data from other nearby vehicles may be obtained, such as a speed of other vehicles in proximity to the vehicle. In some embodiments, the context engine 315 may be configured to override the decision of the AI engine 305 in response to the sanity check, or in some embodiments, to propose additional factors, contexts, data inputs 345, inputs from the managed object 320, or database 335 to be considered before an action is performed in response to the trigger in the respective context. In some embodiments, additional factors, contexts, data inputs 345, inputs from the managed object 320, or database 335 to be considered during a sanity check may be defined by a user, third-party vendor, service provider, and/or software tool, via the learning API 330.

Due to the breadth of control over various aspects of the AI engine 305 which may be modified via the learning API 330, in various embodiments, the learning API 330 may further be configured to selectively allow the modification actions, rules, triggers, user inputs 340, data inputs 345, inputs from managed object 320, or database 335, based on the specific user accessing the learning API 330. For example, the learning API 330 may be configured to authenticate users and selectively authorize the modification the AI engine 305. Thus, end users, third-party vendors, service providers, and software tools may each have respective identifiers and/or credentials. For example, modifications affecting the safety of a product may be restricted by a manufacturer of a product. Thus, end-users and third-party vendors may be restricted from modification of safety-related features of the AI engine 305. Similarly, third-party vendors may want to place limitations on how their specific service or application is utilized. Thus, certain features of a third-party service or application may be restricted from modification by an end-user. Thus, the AI engine 305 may further incorporate user restrictions through authentication and authorization schemes based on the respective user accessing the learning API 330 (e.g., an end-user, third-party vendor, service provider, software tool, etc.).

As described above, the AI engine 305 may be configured to take an action based on one or more user inputs 340, such as an input/query 340a, or a trigger event 340b. In various embodiments, the input/query 340a may include inputs (e.g. a command) or queries provided to the AI engine 305 by a user. The input/query 340a may, in some examples, be provided directly via a user device, such as user/third-party device 325. Thus, the input/query 340a may cause the AI engine 305 to take an action, based on data inputs 345, or inputs from a managed object 320 or database 335. Trigger event 340b may include data indicative of an event being monitored by the AI engine 305. Trigger event 340b may include, without limitation, exceeding or falling below threshold values related to physical phenomena, network conditions, telemetry data, and sensor data. In some embodiments, trigger event 340b may include data obtained from a managed object 320. Thus, the occurrence of the trigger event 340b may cause the AI engine to take an action, based on data inputs 345.

Data inputs 345 may include data stream 345a, metadata 345b. As previously described, data inputs 345 may be obtained from various devices, such as sensor devices, network devices, or managed objects such as managed object 320. In further embodiments, the data inputs 345 may be obtained via a database, such as database 335. For example, in some embodiments, the database 335 may be configured to aggregate data, such as data stream 345a and metadata 345b, from various devices to which the database 335 is coupled. Thus, in some examples, various devices (e.g., managed objects 320, user/third-party device devices 325, or other data sources.

In various embodiments, data from a managed object 320 may be provided to the AI engine 305. As previously described with respect to FIGS. 1 & 2, the managed object 320 may include various types of network resources, sensors, user/third-party device 325, or other devices, or an abstraction of a network resource, sensor, or other device. Accordingly, the managed object 320 may include information regarding the specific network resource, sensors, or other device, as well as data generated by the network resource, sensor or other device, as previously described with respect to FIG. 2. Data from managed object 320 may include user inputs 340, data inputs 345, and data supplied to the database 335. In some embodiments, the managed object 320 may optionally interface with the learning API 330, such that the learning API 330 may access data from the managed object 320, or alternatively, the learning API 330 may be accessed via the managed object 320, such that the managed object 320 may supply data to the AI engine via the learning API 330.

In various embodiments, the user/third-party device 325 may include remotely located devices in communication with the AI engine 305. User/third-party device 325 may include, without limitation, a personal computer, smartphone, digital media player or entertainment system, set-top box, household electronics, household appliances, workstations, central management systems, and server computers. In some embodiments, the user/third-party device 325 may be configured to couple to the AI engine 305 via the learning API 330, to invoke the functions described above with respect to the modification of the behavior of the AI engine 305. In some embodiments, the user/third-party device 325 may further optionally provide data to database 335, which may further be used as an input by the AI engine 305.

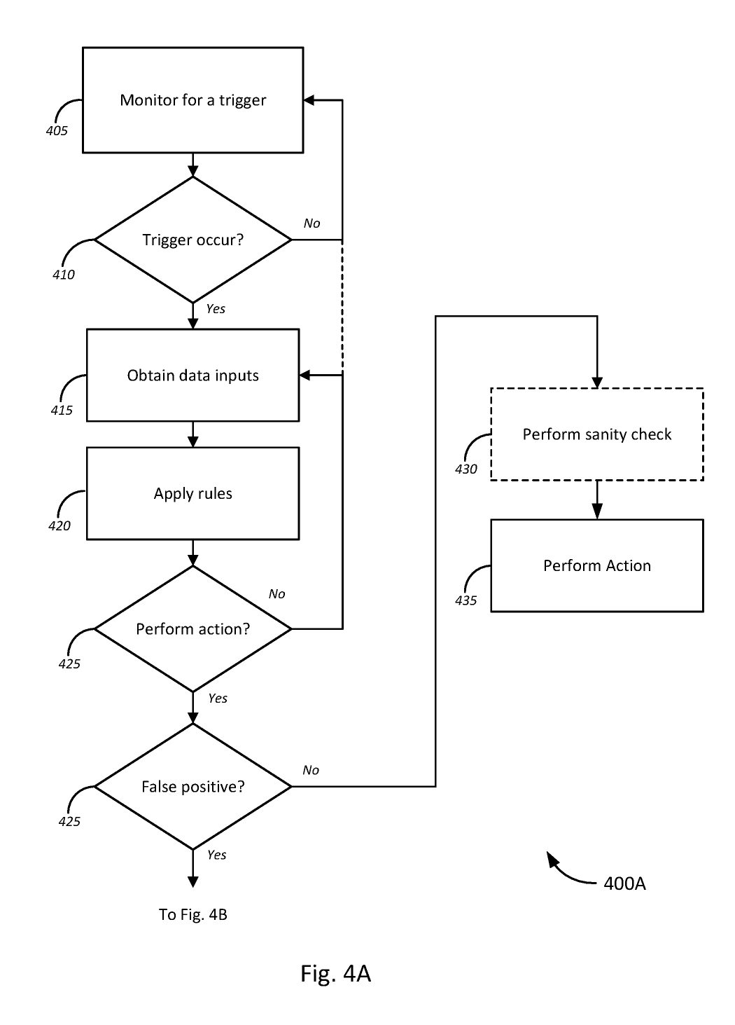

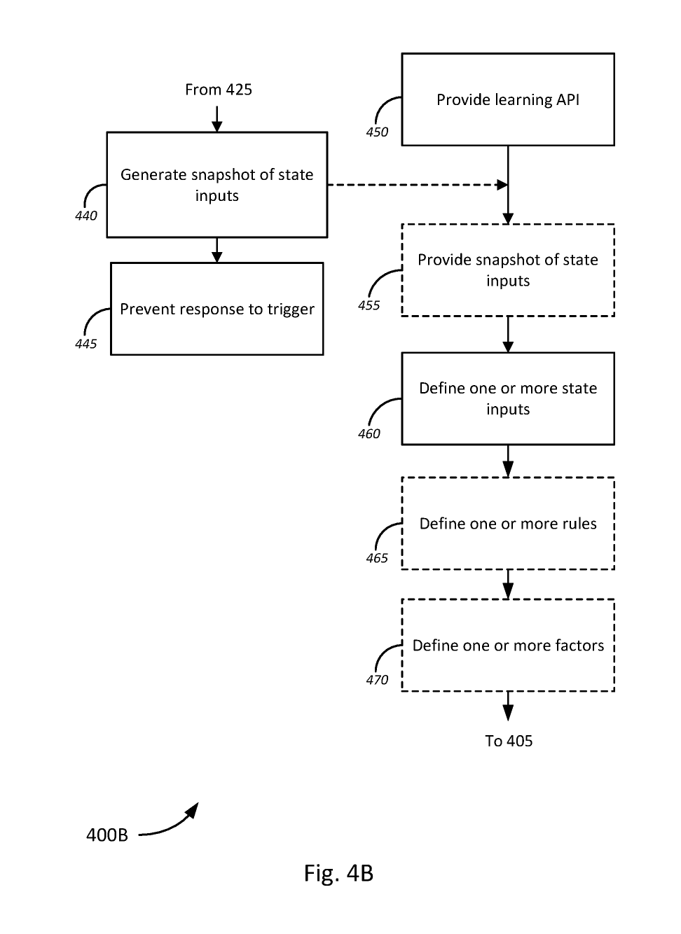

FIG. 4A is a flow diagram of a method 400A for handling a trigger for an AI engine, in accordance with various embodiments. The method 400A begins, at block 405, by monitoring for a trigger. As previously described, monitoring for a trigger may include the monitoring for one or more user inputs. User inputs may include a command or query to perform an action. In some embodiments, user inputs may be supplied by a user, third-party vendor, service provider, or a software tool in response to a prompt. In some embodiments, the AI engine may be configured to monitor for the occurrence of an event, such as a trigger event. For example, in some embodiments, the AI engine may monitor a data stream, a managed object, or a network device for the occurrence of a trigger event. Alternatively, the AI engine may receive a signal indicative of the occurrence of a trigger event.

Thus, at decision block 410, the AI engine may determine whether the trigger has occurred, based on the user inputs or the occurrence of a trigger event. If the AI engine determines that the trigger has not occurred, the method 400A may return, at block 405, to monitoring for a trigger. If a trigger is determined to have occurred, the method 400A may continue, at block 415, by obtaining data inputs. As previously described, data inputs may include, without limitation, data and/or associated metadata from various network devices, a managed object, database, or user device. The data inputs may include, without limitation, data streams of telemetry data, attributes regarding a service or product, performance and usage metrics, and state and fault information.

At block 420, the method 400A may continue by applying one or more rules. In various embodiments, the one or more rules may define algorithms for handling the data inputs, user inputs, or both data inputs and user inputs, in determining an action to perform. As previously described, in some embodiments, this may include the establishing and application of thresholds, via a threshold engine, to determine an action to perform. In further embodiments, the one or more rules may also include algorithms for grouping or correlating the various data inputs and user inputs with associated actions, for example, via a correlation engine as previously described. Once the rules have been applied, at decision block 425, it is determined whether to perform an action and what action should be performed.

Depending on the type of user input (e.g., command or query, or trigger event), if it is determined not to perform an action, based on the rules, data inputs, or user inputs, the method 400A may return, at block 415, to continue obtaining data inputs until the conditions for the one or more rules are satisfied by the data inputs. For example, if a threshold value must be exceeded before an action is performed, the AI engine may continue to monitor the relevant data inputs to determine whether the value has exceeded the threshold value, or whether a condition or event has occurred (e.g., a trigger event). Alternatively, the AI engine may return, at block 405, to monitoring for the occurrence of a trigger. For example, if a trigger event is required to perform an action, the AI engine may continue to monitor for the occurrence of the trigger event before determining whether to take the action again.

If it is determined that an action should be performed, the method 400A may continue, at decision block 425, to determining whether the decision to perform an action is a false positive. As previously described, in various embodiments, an AI engine may be configured to determine whether a decision is a false positive. In some embodiments, the AI engine may be configured to automatically detect (e.g., flag) a false positive based on learned historic usage patterns, and the learned capabilities of a given system or device (e.g., determining that a determined action is outside of the capabilities of a given system). In some embodiments, the AI engine may be configured to allow a user to flag an incorrect decision for further review, for example, via a learning API. In some examples, a validation engine may be configured to control how and when to determine whether a false positive has occurred. In some examples, the algorithms and rules used by the validation engine may also be modified by a user via the learning API. Accordingly, in various embodiments, the AI engine may be configured to allow both manual and automated flagging of decisions made.

If it is determined that a false positive has occurred, the method 400A may progress to block 440 of FIG. 4B, as will be described in greater detail below with respect to FIG. 4B. If it is determined that no false positive has occurred, in some embodiments, the method 400A may continue, at optional block 430, by performing a sanity check. In some embodiments, the AI engine may further include a context engine configured to determine a context for a trigger. As previously described, the context engine may be configured to further modify and define AI engine behavior relative to a respective context. A context may define, without limitation, the type of devices with which the AI engine interacts, and a setting in which the device may be used. In some embodiments, the context engine may be configured determine contexts based on one or more factors. For example, factors may include, without limitation, a geographic location, type of device, user information, service information, application information, sensor inputs (e.g., a microphone, camera, photodetector, global navigation satellite system (GNSS) receiver, accelerometer, gyroscope, moisture reader, thermometer, rangefinder, and motion detector, among many other types of sensors), time of day, or date.

Thus, in some embodiments, performing a sanity check may further include determining a context for the trigger. In some embodiments, sanity testing may be context dependent, and/or rely on one or more factors used to determine the context to intervene before an action is performed by the AI engine. For example, a sanity check may indicate whether one or more additional factors, contexts, data inputs, or inputs from a managed object or database should be considered by the AI engine before an action is performed. In various embodiments, a sanity check may further include historic usage, usage patterns, and other usage information to determine whether a decision made by the AI engine should be performed, prevented from being performed, and/or whether to flag the decision made by the AI engine. At block 435, if after performing the sanity check the action should still be performed, the method 400A may continue by performing the action via the AI engine.

FIG. 4B is a flow diagram of a method 400B for a model-driven AI learning framework, in accordance with various embodiments. The method 400B begins, at block 450, by providing a learning application programming interface. As previously described, in various embodiments, the learning application programming interface may be configured to selectively allow access to certain functions of the AI engine. For example, in some embodiments, the learning API may be configured to allow the trigger, an action taken responsive to a trigger, one or more rules applicable to the trigger, one or more user inputs associated with the trigger, and one or more data inputs to be modified. In some embodiments, functions of the AI engine may be invoked, through the learning API, after first triggering a feedback mechanism. For example, in some embodiments, the feedback mechanism may include a switch, button, command, portal, or other way of gaining access to functions via the learning API.

At block 440, in response to a determination that the decision to perform an action is a false positive, the method 400B may, at block 440, generate a snapshot of state inputs. In some embodiments, the snapshot of state inputs may be generated upon request by a user, or automatically by the AI engine. The snapshot of state inputs may include, without limitation, one or more user inputs, one or more data inputs, trigger events, actions responsive to the trigger, one or more rules, contexts, or one or more factors affecting a context, as previously described. The snapshot of state inputs may then, at optional block 455, be provided to a user or user device.

At block 445, in some embodiments, the method 400B may further prevent the AI engine from responding to the trigger which produced the false positive. In various embodiments, preventing a response to the trigger may include removing the trigger, for example, by modifying one or more actions, one or more rules, one or more user inputs, or one or more data inputs from the AI engine.

At block 460, the method 400B may continue by defining one or more state inputs via the learning API. In various embodiments, defining one or more data inputs may include the addition of new data inputs, or the removal or modification of one or more data inputs. As previously described, the state inputs may include both user inputs and data inputs. User inputs may include, without limitation, user queries, commands, and trigger events. Data inputs may indicate specific data streams, and sources of data to be obtained for responding to the trigger. Thus, in various embodiments, the learning API may be configured to allow modification of both user inputs and data inputs.

At optional block 465, the method 400B may further include defining one or more rules via the learning API. In various embodiments, defining one or more rules may include the addition of new, or the removal or modification of existing rules. As previously described, the one or more rules may include various algorithms for determining whether a trigger has occurred, and a response to the trigger. The one or more rules may include algorithms for correlating data from the one or more user inputs, one or more data inputs, or both user inputs and data inputs. In further embodiments, defining one or more rules may include the modification of one or more thresholds for various data inputs or user inputs. As previously described, thresholds may be defined regarding the values of a data input of the one or more data inputs.

At optional block 470, the method 400B may further include defining one or more factors via the learning API. In various embodiments, defining one or more factors may include the addition of new, or the removal or modification of existing factors. As previously described, the one or more factors may be used to determine a context for a respective trigger or action to be taken responsive to the trigger. Factors may include, without limitation, a geographic location, type of device, user information, service information, application information, sensor inputs (e.g., a microphone, camera, photodetector, global navigation satellite system (GNSS) receiver, accelerometer, gyroscope, moisture reader, thermometer, rangefinder, and motion detector, among other types of sensors), time of day, or date.

In various embodiments, once the necessary definitions have been added or modified via the learning API, the method 400B may return to block 405 of FIG. 4B to monitor for the occurrence of triggers as defined via the learning API.

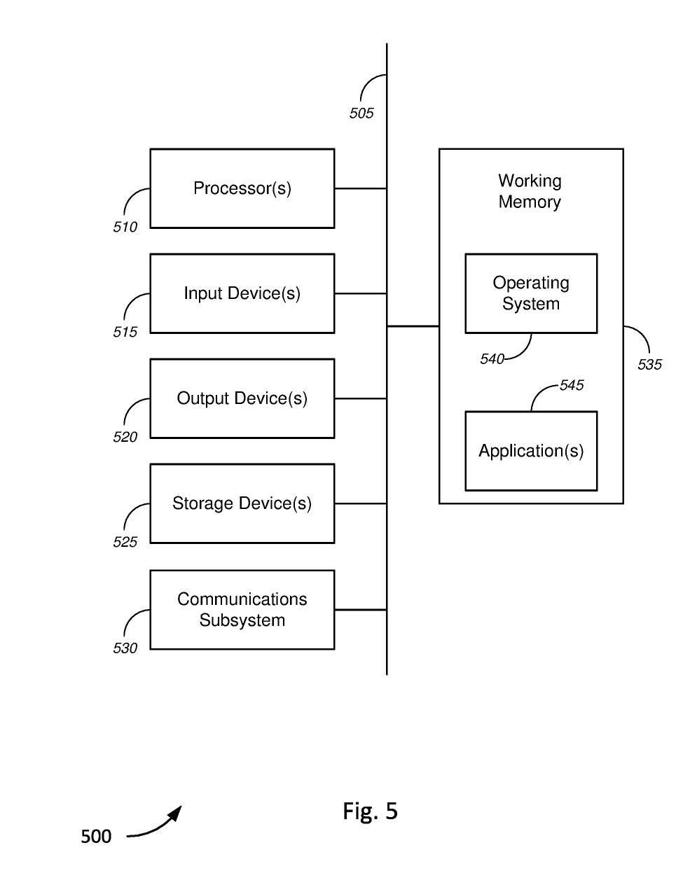

FIG. 5 is a schematic block diagram of a computer system 500 for providing a model-driven AI learning framework, in accordance with various embodiments. FIG. 5 provides a schematic illustration of one embodiment of a computer system 500, such as an AI engine or server computer hosting an AI agent, which may perform the methods provided by various other embodiments, as described herein. It should be noted that FIG. 5 only provides a generalized illustration of various components, of which one or more (or none) of each may be utilized as appropriate. FIG. 5, therefore, broadly illustrates how individual system elements may be implemented in a relatively separated or relatively more integrated manner.

The computer system 500 includes multiple hardware elements that may be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and microcontrollers); one or more input devices 515, which include, without limitation, a mouse, a keyboard, one or more sensors, and/or the like; and one or more output devices 520, which can include, without limitation, a display device, and/or the like.

The computer system 500 may further include (and/or be in communication with) one or more storage devices 525, which can comprise, without limitation, local and/or network accessible storage, and/or can include, without limitation, a disk drive, a drive array, an optical storage device, solid-state storage device such as a random-access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 500 might also include a communications subsystem 530, which may include, without limitation, a modem, a network card (wireless or wired), an IR communication device, a wireless communication device and/or chip set (such as a Bluetooth™ device, an 802.11 device, a WiFi device, a WiMax device, a WWAN device, a Z-Wave device, a ZigBee device, cellular communication facilities, etc.), and/or the like. The communications subsystem 530 may permit data to be exchanged with a network (such as the network described below, to name one example), with other computer or hardware systems, between data centers or different cloud platforms, and/or with any other devices described herein. In many embodiments, the computer system 500 further comprises a working memory 535, which can include a RAM or ROM device, as described above.

The computer system 500 also may comprise software elements, shown as being currently located within the working memory 535, including an operating system 540, device drivers, executable libraries, and/or other code, such as one or more application programs 545, which may comprise computer programs provided by various embodiments (including, without limitation, an AI engine, AI agent, or learning API to perform the processes described above), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, single board computers, FPGAs, ASICs, and SoCs) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally receives the signals, and the bus 505 then might carry the signals (and/or the data, instructions, etc. carried by the signals) to the working memory 535, from which the processor(s) 510 retrieves and executes the instructions. The instructions received by the working memory 535 may optionally be stored on a storage device 525 either before or after execution by the processor(s) 510.

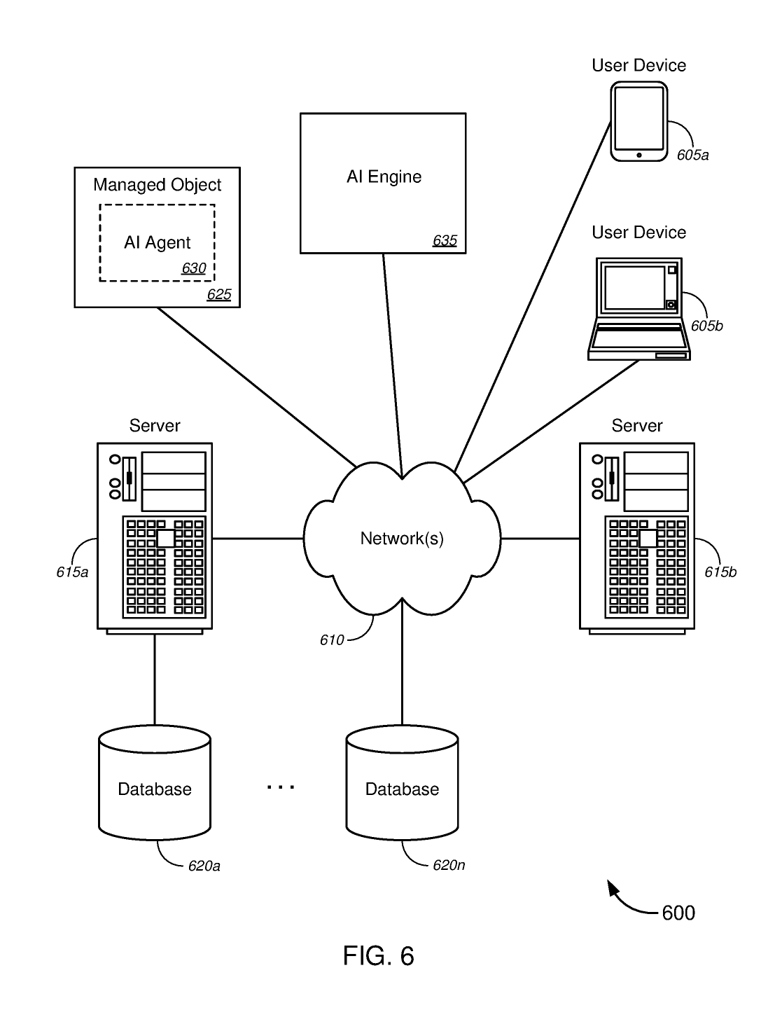

FIG. 6 is a block diagram illustrating a networked system of computing systems, which may be used in accordance with various embodiments. As noted above, a set of embodiments comprises methods and systems for providing a model-driven AI learning framework. The system 600 may include one or more user devices 605. A user device 605 may include, merely by way of example, desktop computers, single-board computers, tablet computers, laptop computers, handheld computers, and the like, running an appropriate operating system, which in various embodiments may include an AI engine and/or learning API as previously described. User devices 605 may further include cloud computing devices, IoT devices, servers, and/or workstation computers running any of a variety of operating systems. In some embodiments, the operating systems may include commercially-available UNIX™ or UNIX-like operating systems. A user device 605 may also have any of a variety of applications, including one or more applications configured to perform methods provided by various embodiments (as described above, for example, an AI agent), as well as one or more office applications, database client and/or server applications, and/or web browser applications. Alternatively, a user device 605 may include any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user devices 605, any number of user devices 605 may be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, MQTT, CoAP, AMQP, STOMP, DDS, SCADA, XMPP, custom middleware agents, Modbus, BACnet, NCTIP 1213, Bluetooth, Zigbee/Z-wave, TCP/IP, SNA™, IPX™, AppleTalk™, and the like. Merely by way of example, the network(s) 610 can each include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications, programs (such as an AI engine, AI agent, or learning API as previously described), web-based services, or other network resources accessible by a client (e.g., managed objects 625, AI agent 630, or AI engine 635). Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™ Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing media content streaming or playback, and, more particularly, to methods, systems, and apparatuses for implementing video tuning and wireless video communication using a single device in which these functionalities are integrated, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (or alternatively, user device 605). Alternatively, a database 620n can be remote from any or all of the computers 605, 615, 625, 635 so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615, 625, 635 can be stored locally on the respective computer and/or remotely, as appropriate.) In one set of embodiments, the database 620 may be a relational database configured to host one or more data lakes collected from various data sources, such as the managed object 625, user devices 605, or other sources. Relational databases may include, for example, an Oracle database, that is adapted to store, update, and retrieve data in response to SQL-formatted commands. The database might be controlled and/or maintained by a database server.

The system 600 may further include an AI engine 635 as a standalone device. In various embodiments, the AI engine 635 may be communicatively coupled to other devices, such as user devices 605, servers 615, databases 620, or managed object 625 directly, or alternatively via network(s) 610. The AI engine 635 may include, without limitation, server computers, workstations, desktop computers, tablet computers, laptop computers, handheld computers, single-board computers and the like, running the AI engine 635, an AI agent, or other AI software, as previously described. AI engine 635 may further include cloud computing devices, servers, and/or workstation computers running any of a variety of operating systems. In some embodiments, the operating systems may include commercially-available UNIX™ or UNIX-like operating systems. The AI engine 635 may further include a learning API configured to perform methods provided by various embodiments.

The system 600 may further include a managed object 625, which may in turn further include an AI agent 630. Managed object 625 may include various types of network resources, and/or abstractions of the network resources. Thus, in some embodiments, the AI engine 635, or optionally the AI agent 630, may be configured to obtain data generated by the managed object 625. Alternatively, the managed object 625 may be configured to transmit data, via the network 610, to the databases 620.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to certain structural and/or functional components for ease of description, methods provided by various embodiments are not limited to any single structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in sequentially for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a specific structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to one embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system comprising:
a user device coupled to a communications network;
an artificial intelligence engine in communication with the user device, the artificial intelligence engine comprising:
a processor;
a non-transitory computer readable medium comprising instructions executable by the processor to:
perform an action responsive to a trigger, based at least in part on one or more data inputs, wherein the trigger includes one or more user inputs;
provide a learning application programming interface configured to allow one or more functions of the artificial intelligence engine to be accessed by the user device;
allow, via the learning application programming interface, the one or more user inputs of the trigger to be defined;
allow, via the learning application programming interface, the one or more data inputs to be defined;
allow, via the learning application programming interface, the action responsive to the trigger to be defined.

2. The system of claim 1, wherein the instructions are further executable by the processor to:
allow, via the learning application programming interface, the one or more user inputs of the trigger, or the one or more data inputs, to be defined by the user device.

3. The system of claim 1, wherein the one or more user inputs include at least one of a query, command, or trigger event.

4. The system of claim 1, wherein the instructions are further executable by the processor to:
determine whether a decision to perform the action responsive to the trigger is a false positive;
generate a snapshot of inputs responsive to a determination of the false positive, the snapshot including at least one of the one or more user inputs, one or more data inputs, and the action performed responsive to the trigger;
providing, via the learning application programming interface, the snapshot to the user device.

5. The system of claim 4, wherein the instructions are further executable by the processor to:
flag the decision responsive to a determination of the false positive;
store the flagged decision in a false positive register, wherein storing the flagged decision includes the snapshot of inputs;
prevent the flagged decision to perform the action responsive to the trigger from being repeated via removal of the trigger.

6. The system of claim 4, wherein the artificial intelligence engine further comprises a validation engine, wherein the instructions are further executable by the processor to:
receive, via the learning application programming interface, one or more rules for performing the action responsive to the trigger, wherein the one or more rules define at least one threshold for at least one of the one or more data inputs;
determine, via the validation engine, the existence of the false positive based, at least in part, on the one or more rules.

7. The system of claim 1, wherein the artificial intelligence engine further comprises a context engine, wherein the instructions are further executable by the processor to:
determine, via the context engine, a context for the trigger, based at least in part on one or more factors, wherein the factors include at least one of a geographic location, user information, a type of the user device, service, or application associated with the trigger;
allow, via the learning application programming interface, at least one of the one or more factors to be defined;
determine, via the context engine, the action responsive to the trigger based, at least in part, on the context.

8. The system of claim 1, further comprising a database in communication with the artificial intelligence engine, wherein the instructions are further executable by the processor to:
receive, via the learning application programming interface, a definition of at least one of the one or more data inputs, wherein the definition includes at least one data stream of the database; and
obtain, via the database, the at least one of the one or more data inputs from the at least one data stream of the database.

9. The system of claim 1, further comprising a managed object in communication with the artificial intelligence engine, wherein the instructions are further executable by the processor to:
receive, via the learning application programming interface, a definition of at least one of the one or more data inputs, wherein the definition includes at least one data stream of the managed object;
obtain, via the managed object, the at least one of the one or more data inputs from the data stream of the managed object, wherein the data stream includes at least one of product or service attributes, usage and performance metrics, state and fault information, and metadata.

10. The system of claim 1, wherein the instructions are further executable by the processor to:
authenticate, via the learning application programming interface, a user accessing the artificial intelligence engine;
authorize, via the learning application programming interface, a subset of the one or more user inputs of the trigger, the one or more data inputs, or the action responsive to the trigger to be defined by the user device, based at least in part on the user.

11. An apparatus comprising:
a processor;
a non-transitory computer readable medium comprising instructions executable by the processor to:
perform an action responsive to a trigger, based at least in part on one or more data inputs, wherein the trigger includes one or more user inputs;
provide a learning application programming interface configured to allow one or more functions of the artificial intelligence engine to be accessed by a user;
allow, via the learning application programming interface, the one or more user inputs of the trigger to be defined by the user;
allow, via the learning application programming interface, the one or more data inputs to be defined by the user;
allow, via the learning application programming interface, the action responsive to the trigger to be defined by the user.

12. The apparatus of claim 11, wherein the one or more user inputs include at least one of a query, command, or trigger event.

13. The apparatus of claim 11, wherein the instructions are further executable by the processor to:
determine whether a decision to perform the action responsive to the trigger is a false positive;
generate a snapshot of inputs responsive to a determination of the false positive, the snapshot including at least one of the one or more user inputs, one or more data inputs, and the action performed responsive to the trigger;
providing, via the learning application programming interface, the snapshot to the user device.

14. The apparatus of claim 13, wherein the instructions are further executable by the processor to:
receive, via the learning application programming interface, one or more rules for performing the action responsive to the trigger, wherein the one or more rules define at least one threshold for at least one of the one or more data inputs;
determine the existence of the false positive based, at least in part, on the one or more rules.

15. The apparatus of claim 11, wherein the instructions are further executable by the processor to:
determine a context for the trigger, based at least in part on one or more factors, wherein the factors include at least one of a geographic location, user information, a type of the user device, service, or application associated with the trigger;
allow, via the learning application programming interface, at least one of the one or more factors to be defined by the user;
determine, via the context engine, the action responsive to the trigger based, at least in part, on the context.

16. The apparatus of claim 11, wherein the instructions are further executable by the processor to:
authenticate, via the learning application programming interface, a user accessing the artificial intelligence engine;
authorize, via the learning application programming interface, a subset of the one or more user inputs of the trigger, the one or more data inputs, or the action responsive to the trigger to be defined by the user device, based at least in part on the user.

17. A method comprising:
performing, via an artificial intelligence engine, an action responsive to a trigger, based at least in part on one or more data inputs, wherein the trigger includes one or more user inputs;
providing, at the artificial intelligence engine, a learning application programming interface configured to allow one or more functions of the artificial intelligence engine to be accessed;
defining, via the learning application programming interface, the one or more user inputs of the trigger;
defining, via the learning application programming interface, the one or more data inputs;
defining, via the learning application programming interface, the action responsive to the trigger.

18. The method of claim 17, further comprising:
determining, with the artificial intelligence engine, whether a decision to perform the action responsive to the trigger is a false positive;
generating, via the artificial intelligence engine, a snapshot of inputs responsive to a determination of the false positive, the snapshot including at least one of the one or more user inputs, one or more data inputs, and the action performed responsive to the trigger;
providing, via the learning application programming interface, the snapshot to a user device.

19. The method of claim 18, further comprising:
receiving, via the learning application programming interface, one or more rules for performing the action responsive to the trigger, wherein the one or more rules define at least one threshold for at least one of the one or more data inputs;
determining, via the validation engine, the existence of the false positive based, at least in part, on the one or more rules.

20. The method of claim 17, further comprising:
determining, via the artificial intelligence engine, a context for the trigger, based at least in part on one or more factors, wherein the factors include at least one of a geographic location, user information, a type of the user device, service, or application associated with the trigger;
defining, via the learning application programming interface, at least one of the one or more factors;
determining, via the artificial intelligence engine, the action responsive to the trigger based, at least in part, on the context.
